(19) United States
(12) Patent Application Publication
(10) Pub. No.: US 2013/0200289 A1
(43) Pub. Date: Aug. 8, 2013

(54) CONTROL VALVE FOR A CAM SHAFT ADJUSTER

(71) Applicants: Jens Hoppe, Erlangen (DE); Stefan Konias, Erlangen (DE)

(72) Inventors: Jens Hoppe, Erlangen (DE); Stefan Konias, Erlangen (DE)

(21) Appl. No.: 13/879,931

(22) PCT Filed: Aug. 22, 2011
(86) PCT No.: PCT/EP11/64330

§ 371 Date: Apr. 17, 2013

(30) Foreign Application Priority Data
Oct. 25, 2010 (DE) 102010049551.4

(51) Int. Cl. F01L 1/344; F16K 25/04

(52) U.S. Cl. CPC F01L 1/3442; F16K 25/04
USPC 251/366; 251/368

(57) ABSTRACT

A control valve for a cam shaft adjuster, including a valve housing and a control piston, which is designed as an injection-molded product and is axially displaceably mounted within the valve housing and which has a substantially tubular main body, wherein the control piston, on an end face, has an actuating surface for a control component. To this end, the control piston includes, at an end thereof, an axially extending molded-on component which includes a gate point on one of the lateral faces thereof. Such a design of a control valve allows the control piston to be securely guided within the valve housing at low manufacturing cost of the control piston.

The present invention relates to a control valve for a cam shaft adjuster, comprising a valve housing as well as a control piston which is designed as an injection-molded product and is axially displaceably mounted within the valve housing, and which has a substantially tubular main body, the control piston having an actuating surface for a control component [on] one end face.

### BACKGROUND

A cam shaft adjuster is basically used to adjust the phase position between a cam shaft and a crankshaft in an internal combustion engine in a targeted manner and thus allows for the optimized setting of the valve opening times. In this way, an efficiency enhancement of the internal combustion engine may be achieved which is particularly noticeable through performance gain and fuel savings.

A cam shaft adjuster usually comprises a stator, a rotor positioned in the stator, as well as two sealing covers. The sealing covers delimit the pressure chambers which are formed in the stator and which are formed by webs extending radially inward away from the stator walls. The rotor blades of the rotor, which is accommodated within the stator, are positioned in these pressure chambers, so that the torsion angle of the rotor is delimited by the webs in the stator.

During operation, the stator is acted on by a hydraulic medium, whereby the rotor rotates in relation to the stator within the pressure chambers. In this way, a rotation of the cam shaft in relation to the crankshaft may be achieved in a predetermined angle range and the opening times of the valves in an internal combustion engine may be controlled thereby in a targeted manner.

A precise metering of the hydraulic medium is necessary for a targeted adjustment. For this purpose, control valves are usually used which control the supply of the hydraulic medium to the cam shaft adjuster. A control valve generally comprises a valve housing and a control piston which is axially displaceably mounted within the valve housing and which is typically operated with the aid of an electromagnet.

An electromagnetic hydraulic valve of the aforementioned type is known from WO 2006 079 382 A1, this valve having a valve housing in the shape of a hollow cylinder in which an axially displaceable control piston is accommodated. The axial displacement of the control piston takes place via a control component which is designed as a push rod activatable by an electromagnet. The control piston is reset by a pressure spring acting against the force of the push rod. A separate bush is situated at the end of the control piston lying in the direction of the push rod. The bush is pushed onto the control piston with its end-face side and is fastened there. The bush is used as an actuating surface for the activated push rod and thus enables the displacement of the control piston.

The disadvantage of the above-mentioned configuration is, however, that the use of separate components is necessary to ensure the function of the control valve. By taking into account the associated manufacturing cost, the use of a bush on the control piston does thus not represent the optimal approach.

### SUMMARY OF THE INVENTION

It is an object of the present invention to provide an improved control valve with regard to the prior art which allows the control piston to be securely guided within the valve housing at low manufacturing cost.

The present invention provides a control valve for a cam shaft adjuster, comprising a valve housing as well as a control piston which is designed as an injection-molded product and is axially displaceably mounted within the valve housing, and which has a substantially tubular main body, the control piston having an actuating surface for a control component on its end face. It is provided here that on its end side the control piston has an axially extended molded-on component which comprises a gate point on one of its lateral faces. In other words, a molded-on component having a lateral injection point is used for the injection molding of the control piston so that an actuating surface may be formed to be free of a bothersome gate point, which remains as an artifact of the injection molding, as a direct part of the molded-on component.

As already mentioned at the outset, a hydraulic medium is needed to operate the cam shaft adjuster which is metered with the aid of the control piston. Accordingly, the control piston must, in particular, be permanently functional even at high temperatures and by taking into account the forces acting on it during operation. In order to meet these requirements, metallic control pistons are often used which are produced to be massive.

When they are used, there is, however, the risk of a premature wear of the components due to friction arising between the control piston and the valve housing when the control piston is displaced axially. Furthermore, the control pistons require cost-intensive and complex processing by subsequently curing and grinding the sliding and actuating surfaces.

As an alternative thereto, control pistons which are produced as injection-molded parts are used, for example. When manufacturing molded parts with the aid of injection molding, the necessary material is filled into a casting mold starting from a so-called injection point. Taking into account the flow path and the filling volume, it is thus possible to fill the casting mold uniformly and symmetrically. In cylindrical bodies, such as a control piston in the present case, the injection point is usually placed centrically on its end face in order to thus enable a uniform distribution of the material in the casting mold.

However, a gate, which is due to the manufacturing process and which is referred to in the following as a “gate point,” occurs on the molded product at the injection point during the injection molding, this gate having to be removed by complex postprocessing. Here, insufficient postprocessing results in a bothersome remainder of a sprue, i.e., of a gate point, which is particularly unfavorable in the case of a control component making contact and does not allow an exact control of the control piston.

The present invention surprisingly recognizes that a control piston designed as an injection-molded product may be used despite the aforementioned problems if it has on its end side an axially extending molded-on component which comprises the gate point on one of its lateral faces. Such a control piston meets the requirements for a simple and cost-effective manufacture as well as for its exact displaceability within the valve housing.

The design as an injection-molded product allows for the desirable uniform and homogeneous tool or mold filling to be accounted for during manufacture, since the gate point is located on one end side of the control piston, but is formed there on one of the lateral faces. At the same time, the manufacturing costs and the production complexity may be kept as low as possible, since a complex postprocessing may be omitted.

Directly usable molded parts may be manufactured in great numbers and with high accuracy with the aid of injection molding. For this purpose, the material is usually injected into a hollow injection mold, the hollow space determining the shape and the surface structure of the molded product to be produced. Here, the surface of the molded product may be selected almost arbitrarily. In particular with regard to the displaceable accommodation of the control piston in the valve housing, the use of the injection molding process thus represents a good possibility of designing a smooth structure of the lateral surface of the control piston and thus of ensuring the necessary sliding properties.

Here, metallic materials or plastics are basically conceivable as the injection-molded materials, it being possible to adapt the selection of the material to the forces and stresses occurring during the operation of the cam shaft adjuster or the internal combustion engine.

The control piston is advantageously designed as a hollow cylinder which is open at the ends on both sides and which has a substantially consistent inner diameter. It is, in particular, manufactured as one piece with the aid of the injection molding process. As already mentioned at the outset, the control piston is axially displaced by the energization of an electromagnet within a valve housing during the operation of an internal combustion engine. The electromagnet typically has a magnet armature and a push rod for this purpose, the push rod being in contact with one end face of the control piston on its actuating surface.

The actuating surface is accordingly designed, preferably entirely or at least partially, as a contact area for the push rod. The actuating surface may be, for example, designed to be flat or also curved, it, however, matching the contacting end of the push rod in any case. Accordingly, other alternatives are also conceivable which allow an exact guidance of the control piston within the valve housing in addition to the above-mentioned embodiments. The actuating surface is preferably designed as a part of the molded-on component. This is now made possible due to the lateral gate point. It is no longer necessary to postprocess the gate point.

The valve housing is preferably designed as a hollow cylinder. The inner diameter in this case corresponds, in particular, to the outer diameter of the control piston. To adjust the cam shaft in relation to the crankshaft, the valve housing may be acted on by a hydraulic medium. For this purpose, the valve housing usually has multiple circumferential ring grooves on its outer periphery which are axially spaced apart from one another and have through openings via which the hydraulic medium may enter the inner chamber of the valve housing or be discharged therefrom.

The control piston may be designed on its outer periphery to have annular control sections, which cover and close the through openings of the ring grooves in the valve housing depending on the energization of the electromagnet. In this way, the hydraulic medium may only act on the valve housing via the desirable through openings.

In one advantageous embodiment of the present invention, the gate point is located outside of the actuating surface for the control component. In other words, the actuating surface does not have a gate point. Since the actuating surface is used as the contact area for the push rod, a secure guidance of the control piston may be ensured by this spatial separation of the gate point and the actuating surface. This prevents, for example, a tilting or jamming of the control piston during displacement with the aid of the push rod.

Furthermore, the gate point is preferably situated eccentrically in relation to the middle axis of the control piston. The eccentrically situated gate point enables a central placement on the actuating surface, since a gate point has not formed here.

In another advantageous embodiment of the present invention, the molded-on component comprises a distribution system having a number of distribution webs extending from the gate point to the outside. During the manufacture of the control piston with the aid of injection molding, the material is filled into the distribution system starting from the injection nozzle via the gate. Here, the gate represents the connection between the injection nozzle for filling the casting mold and the injection point or the gate point. Starting from the injection point, the material enters the distribution system and is distributed there symmetrically. In other words, the distribution system is designed in such a way that the material reaches all areas of the casting mold to be filled almost at the same time having the same state and pressure. The distribution system thus accomplishes a uniform filling of the injection mold starting from the lateral injection point.

The distribution webs are, in particular, designed for the symmetric distribution of the material in such a way that pressure losses due to length variations are avoided during the filling of the material. For this purpose, they preferably extend from the gate point to the outside, so that the material injected into the mold may be distributed desirably uniformly starting from the injection point or the later gate point. The distribution webs of the distribution system have in this case, in particular, the same diameter and the same length, so that the material is able to reach all areas of the control piston at the same time.

In one advantageous embodiment of the present invention, the distribution system additionally comprises a number of axially extending connecting webs via which the distribution webs are connected to the main body of the control piston. The connecting webs are also used to distribute the material and enable a uniform distribution of the material in the form of the main body. Similarly to the distribution webs, the connecting webs are short, so that here too almost no pressure losses are recorded. Here, the actuating surface for the control component may be formed at least partially by distribution webs.

The distribution webs and the connecting webs are advantageously interconnected or they merge into one another. The material flowing through the distribution webs from the injection point or the later gate point reaches the axially extending connecting webs via the distribution webs during injection molding and flows to the main body of the control piston from there. This embodiment is advantageous, for example, since the strength properties, the shrinkage of the material or of the mold resulting after the curing, as well as the orientation of the material are a function of its flow direction during the manufacture. For this reason, it is advantageous to establish the flow direction in parallel to the main stress direction, since improved mechanical properties are achieved in this way. This also applies, in particular, to fiber-filled plastics in which the fibers must be distributed as homogeneously as possible across the mold during injection to achieve consistent properties in every place.

Overall, the distribution system offers the possibility of symmetrically distributing the material in the casting mold via the distribution webs and the connecting webs starting from the gate point. The composition of the cured control piston is accordingly homogeneous, so that a uniform distribution and orientation of individual material components may be ensured. This, in particular, results in homogeneous strength properties as well as in a uniform thermal expansion of the entire control piston, thus, in turn, enabling unimpeded movement within the valve housing.

The geometry of the distribution system is furthermore preferred to be rotationally symmetric in relation to the middle axis of the control piston. The distribution system may thus be overlapped by itself by being rotated around the middle axis at a certain angle. There are different orders of rotational symmetry, a 2-fold rotational symmetry, for example, meaning that a rotation by 180° images the object on itself. Due to the rotational symmetry of the distribution system, a uniform and symmetric filling of the rotationally symmetric casting mold of the main body is, in particular, implemented during the manufacture of the control piston. The finished molded product, i.e., the control piston which is ready for operation, then preferably has the same material composition and, resulting therefrom, the same mechanical and thermal properties in every place. Furthermore, it is possible to increase the stability of the control piston due to the resulting rotationally symmetric geometry of the molded-on component.

The control piston is preferably made of a plastic. Plastics are particularly suitable due to their diversity and due to the possibility of varying their technical properties within a wide range. By selecting the additives added to the starting plastic, it is, for example, possible to influence in a targeted manner the hardness, the temperature resistance, and the dimensional stability under heat, as well as the chemical resistance. Furthermore, plastics or also molten plastics are easy to process and thus in particular offer the possibility of manufacturing a control piston with the aid of injection molding.

In particular, duroplastic materials are suitable for this purpose. Duroplastic materials distinguish themselves in that they can no longer be deformed after curing. They are hard glass-like polymers which are manufactured with the aid of polycondensation. For this purpose, polymers are either cross-linked among themselves or together with monomers. They consist of spatially closely cross-linked macromolecules and are particularly hard. Since thermosetting plastics may be subjected to great thermal and mechanical stresses, they are accordingly well suitable for the manufacture of a control piston. Phenolplastics may be used, for example. Phenolplastics are duroplastic synthetic materials based on phenolic resins manufactured using polycondensation. They distinguish themselves by their hardness and their breaking strength.

The material of the control piston particularly preferably contains mineral fibers and/or glass fibers in a range between 75 percent by volume and 95 percent by volume. In general, inorganic fibers which are either amorphous or crystalline in nature are referred to as mineral fibers. Glass fibers, in particular, belong to the group of amorphous mineral fibers. Plastics which are reinforced with mineral fibers and/or glass fibers and have a duroplastic matrix can no longer be deformed after curing or cross-linking of the matrix. Such plastics, however, have a wide temperature range of application. This applies, in particular, to so-called hot curing systems which are cured at high temperatures. The thermal expansion of a duroplastic material having a fiber content within the aforementioned range corresponds approximately to that of steel, so that jamming of the piston may be avoided during the axial displacement of the control piston within the valve housing. Furthermore, a good oil resistance is ensured due to minor swelling of the material. Plastics which are reinforced with mineral fibers and/or glass fibers and have a duroplastic matrix furthermore have high strengths as well as a good dimensional stability. Additionally, they are resistant to aging and thus increase the longevity of the control piston.

The control piston is produced as a two-part piece according to one advantageous embodiment of the present invention. Due to the two-part production it is, in particular, possible to produce flow-enhancing structures for the hydraulic medium on the inside of the control piston. The casting molds used to manufacture the control piston may be produced thanks to the two-part production having accordingly complex contours, i.e., negative contours for the molded product to be produced. The particular contours, e.g., undercuts, depend on the requirements placed on the control piston.

### BRIEF DESCRIPTION OF THE DRAWINGS

In the following, exemplary embodiments of an invention are elucidated in greater detail with reference to one drawing.

FIG. 1 shows a control valve having a control piston in a longitudinal section,

FIG. 2 shows the control piston according to FIG. 1 in a three-dimensional representation,

FIG. 3 shows a top view of the control piston according to FIGS. 1 and 2,

FIG. 4 shows another control piston in a longitudinal section,

FIG. 5 shows a top view of the control piston according to FIG. 4,

FIG. 6 shows another control piston in a two-part configuration in a longitudinal section,

FIG. 7 shows the control piston according to FIG. 6 in a three-dimensional representation,

FIG. 8 shows a top view of the control piston according to FIGS. 6 and 7, and

FIG. 9 shows another control piston in a longitudinal section.

### DETAILED DESCRIPTION

FIG. 1 shows a control valve 1 having a control piston 3 in a longitudinal section. Control piston 3 is axially displaceably mounted in a valve housing 5. Control piston 3 is manufactured from a plastic with the aid of an injection molding process. In this case, a thermosetting plastic which has a glass fiber content of 85% is used as the plastic.

The design as an injection-molded product makes a uniform and homogeneous filling of the mold during the manufacture of control piston 3 possible. The use of plastic having a high fiber content ensures in this case good temperature resistance, minor swelling of the material, as well as high strengths and a good dimensional stability of control piston 3. At the same time, the manufacturing cost and the production complexity may be kept as low as possible.

Control piston 3 has a substantially tubular main body 7 and an axially extending molded-on component 11 on its end face 9. Molded-on component 11 comprises as such already an actuating surface 13, designed as a flat contact area, for a push rod (not illustrated).

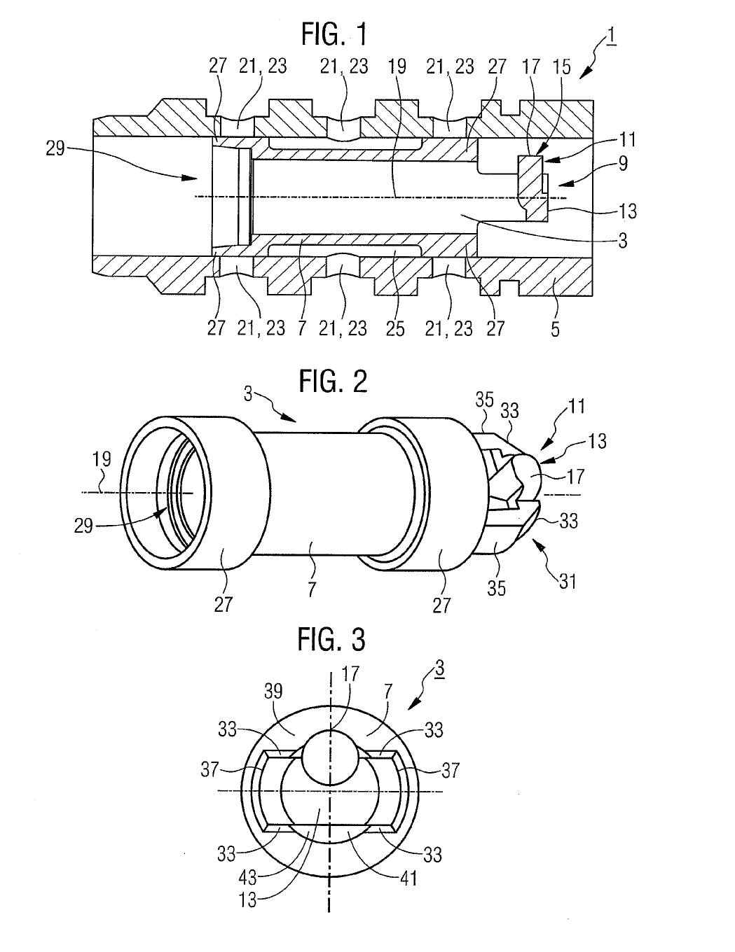

Molded-on component 11 comprises on one of its lateral faces 15 a gate point 17 as a result of the manufacture using injection molding. In other words, the basic configuration of control piston 3 has been filled at this gate point 17 starting from an injection point. Gate point 17 is in this case located outside of actuating surface 13 for the control component and is formed eccentrically in relation to middle axis 19 of control piston 3. Since the details of molded-on component 11 are visible only to a limited extent, reference is made here to the description in FIG. 2.

Control piston 3 itself is designed as a hollow cylinder which is open at the ends on both sides and which has a substantially consistent inner diameter. During the operation of an internal combustion engine, control piston 3 is axially displaced within valve housing 5 by the energization of an electromagnet (not shown). In this case, the end of the push rod makes contact with actuating surface 13 of the control piston and it is displaced axially within the valve housing by the energization of the electromagnet.

Similarly to control piston 3, valve housing 5 is designed as a hollow cylinder. On its outer periphery, it has three circumferential ring grooves 21 which are axially spaced apart from one another and have through openings 23. Hydraulic medium may enter inner chamber 25 of valve housing 5 or be discharged therefrom via these through openings 23. To be able to control to what extent the valve housing is acted on by the hydraulic medium, through openings 23 are partially covered by annular control section 27 formed on the outer periphery of control piston 3. In this way, the hydraulic medium may flow in a targeted manner only through those through openings 23 which are necessary for adjusting a cam shaft adjuster or a rotor mounted within a stator.

A pressure spring, which resets control piston 3 against the force of the push rod, may be positioned on side 29 of control piston 3 which is opposite molded-on component 11 or actuating surface 13. The pressure spring is not shown in FIG. 1.

FIG. 2 shows control piston 3 according to FIG. 1 in a three-dimensional representation. Here, molded-on component 11, which extends in the axial direction, is clearly recognizable next to annular control sections 27, which are formed at the ends on both sides.

Molded-on component 11 comprises a distribution system 31 having distribution webs 33 extending from gate point 17 to the outside, as well as connecting webs 35. The geometry of distribution system 31 is rotationally symmetric in relation to middle axis 19 of control piston 3. In this way, a uniform and symmetric mold filling may be achieved during the manufacture of control piston 3. The stability of control piston 3 is additionally increased.

Distribution system 31 is designed in such a way that during the manufacture of control piston 3 the material reaches all areas of the casting mold to be filled almost at the same time having the same state and pressure. For this purpose, the plastic is filled into distribution system 31 starting from an injection nozzle (not shown) at the location of gate point 17 during the manufacture. The material is symmetrically distributed in the mold via distribution webs 33 and axial connecting webs 35. Furthermore, distribution webs 33 or gate point 17 and thus actuating surface 13 are spaced apart from main body 7 via axial connecting webs 35.

Distribution webs 33 extend for this purpose from gate point 17 to the outside having an identical length and eventually merge into connecting webs 35 extending axially toward the main body. Distribution webs 33 of distribution system 31 have the same diameter and the same length, so that the material reaches all areas of control piston 3 at the same time.

It is furthermore apparent that circular actuating surface 13 does not have gate point 17, i.e., it is outside of actuating surface 13. This configuration makes it possible for a complex postprocessing of actuating surface 13 to be omitted. Actuating surface 13 thus offers a reliable contact area for a push rod so that an exact guidance of control piston 3 is possible within valve housing 5. There is no need for processing gate point 17 which remains as an artifact of the manufacturing process.

Overall, such a control piston 3 may be manufactured which has comparable strength properties in every place due to the uniform distribution of the individual material components.

FIG. 3 shows a top view of control piston 3 from the side of molded-on component 11. Gate point 17 and distribution webs 33 extending from gate point 17 to the outside are clearly recognizable here. It is recognizable here that during the manufacture of control piston 3 the material is distributed further via additional connecting channels 37 from gate point 17 to distribution webs 33 extending to the outside.

Connecting channels 37 run along peripheral surface 39 of main body 7 in a crescent-shaped manner and merge into a molded-on element 43. Starting from there, the material also flows to main body 7 via axial connecting webs 35, so that a particularly good and uniform distribution is achieved overall across the entire body.

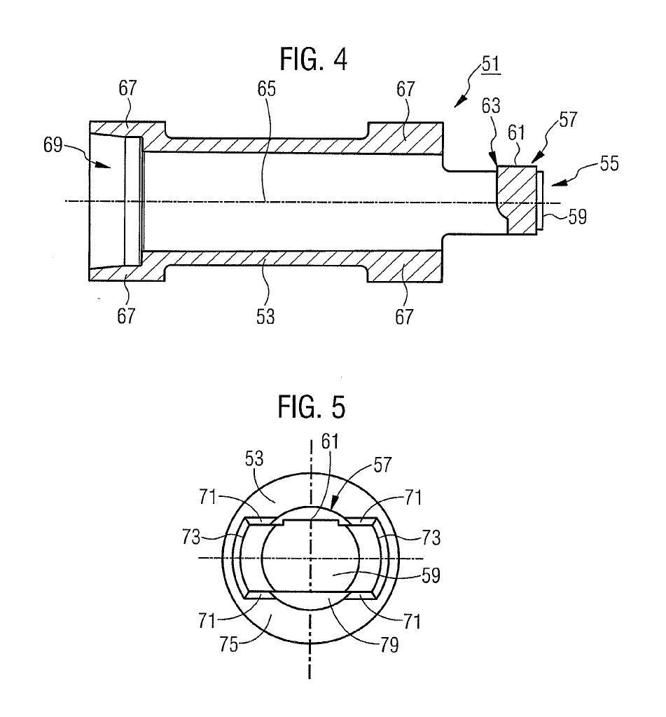

In FIG. 4, another control piston 51 is shown in a longitudinal section. Control piston 51 is also manufactured from a plastic with the aid of an injection molding process. In this case, a thermosetting plastic which has a glass fiber content of 90% is used as the plastic. Control piston 51 also has a substantially tubular main body 53 and has an axially extending molded-on component 57 having an actuating surface 59 on its end face 55. Actuating surface 59 is designed as a flat contact area for a [push rod] (not illustrated).

Gate point 61 is formed on a lateral face 63 of molded-on component 57 due to the manufacturing process and is thus located outside of actuating surface 59 for the control component. Gate point 61 is formed outside of the center with regard to middle axis 65 of control piston 51. Molded-on component 57 of course also has connecting webs as well as axially extending distribution channels, as also described in FIGS. 1 through 3. They are, however, not visible due to the representation. Reference is made here to the description in FIG. 5.

On its outer periphery, control piston 51 has, as also shown in FIGS. 1 through 3, two annular control sections 67 at the end of each side which in the installed state cover the through openings in the ring grooves of a valve housing and may thus prevent the hydraulic medium from entering.

Furthermore, a pressure spring for resetting control piston 51 may be positioned on side 69 of control piston 51 which is opposite molded-on component 57. The pressure spring is not shown here.

FIG. 5 shows a top view of control piston 51 according to FIG. 4. Gate point 61 is formed outside of the center on lateral face 63 and is spatially separated from actuating surface 59. Molded-on component 57 has distribution webs 71 which extend from gate point 61 to the outside. Distribution webs 71 merge into connecting webs (not visible) extending axially in the direction of main body 53, whereby the plastic is distributed symmetrically in the mold during the production of control piston 51.

Molded-on component 57 is furthermore designed to have additional connecting channels 73 which run along peripheral surface 75 of main body 53 in a crescent-shaped manner, as also shown in FIG. 3. The material converges in a molded-on element 79 via connecting channels 73 and is distributed uniformly from there.

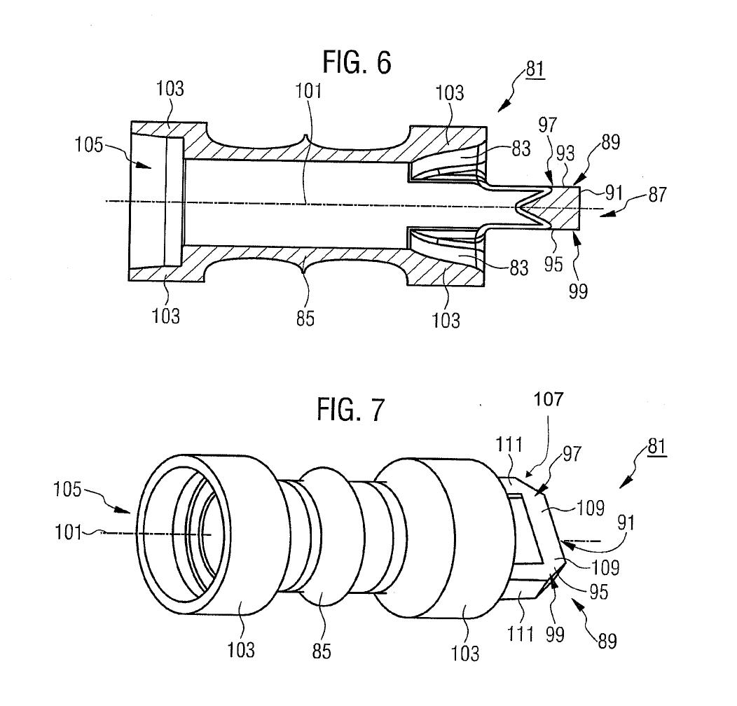

In FIG. 6, a two-part configuration of another control piston 81 is recognizable. Due to the two-part production it is, in particular, possible to introduce flow-enhancing structures 83 for the hydraulic medium on the inside of control piston 81.

Both parts of control piston 81 are manufactured from a thermosetting plastic, which has a glass fiber content of 80%, with the aid of an injection molding process. Similarly to the previously described figures, control piston 81 has a substantially tubular main body 85 and has an axially extending molded-on component 89 on its end face 87. Molded-on component 89 comprises an actuating surface 91 for a push rod (not shown).

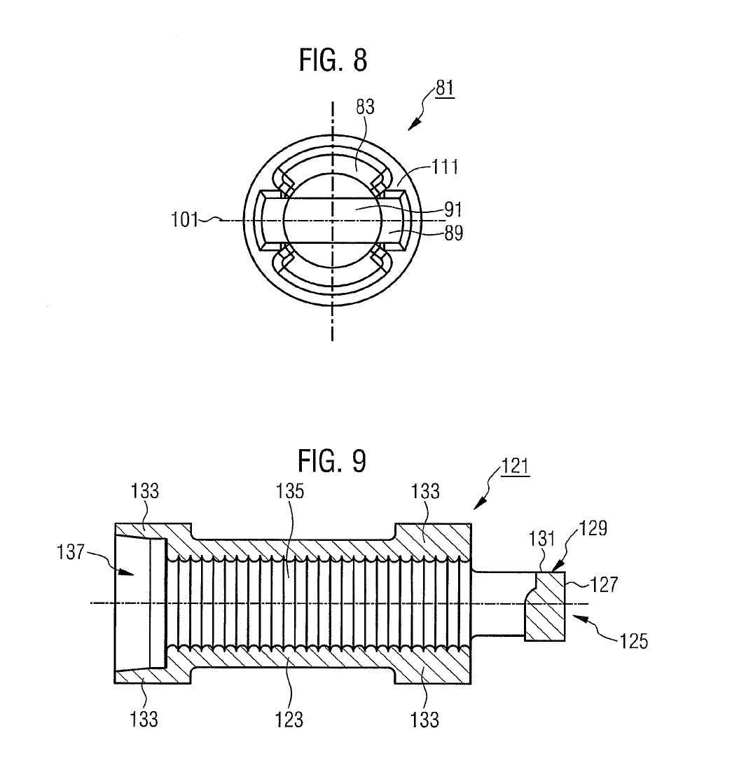

Due to the two-part production, molded-on component 89 has two gate points 93, 95, each of which is formed on a lateral face 97, 99 of molded-on component 89 outside of actuating surface 91. Gate points 93, 95 are situated eccentrically in relation to middle axis 101 of control piston 81 as a result of the injection points selected here. A detailed description of molded-on component 89 may be derived from FIGS. 7 and 8.

In the installed state, control piston 81 has two annular control sections 103 on its outer periphery at the end of each side which cover the through openings in the ring grooves of a valve housing. In the installed state, a pressure spring for resetting control piston 81 may additionally be positioned within a valve housing on side 105 which is opposite actuating surface 91. The pressure spring is not shown in FIG. 6.

FIG. 7 shows control piston 81 according to FIG. 6 in a three-dimensional representation. Here, flow-enhancing structures 83 on the inside of main body 85, which has the shape of a hollow cylinder, are not recognizable. However, molded-on component 89 which is designed in the shape of a bracket is visible very well on the side of control piston 81 facing the push rod.

Molded-on component 89 is designed to have a distribution system 107, via which the plastic reaches all areas of the casting mold to be filled almost at the same time having the same pressure. Distribution system 107 is designed as a bracket, gate points 93, 95 being formed on this bracket, each on one of lateral faces 97, 99 of molded-on component 89, which are separated from actuating surface 91, as already described above.

In order to distribute the plastic in a symmetric and homogeneous manner during the manufacture of control piston 81, distribution system 107 comprises distribution webs 109 which extend to the outside away from gate point 93. Distribution webs 109 are connected via connecting webs 111 which extend axially to main body 85 and via which the material is symmetrically distributed in the mold.

Distribution webs 109 of distribution system 107 have the same dimensions and length, so that the material reaches all areas of control piston 81 at the same time. Control piston 81 accordingly has the same material composition and the same mechanical and thermal properties in every place.

Distribution system 107 has a rotationally symmetric geometry in relation to middle axis 101 when control piston 81, which is produced as a two-part piece, is fully assembled. In the present case, distribution system 107 is formed with a 2-fold rotational symmetry and may be imaged on itself by being rotated by 180°. With the aid of the rotational symmetry of distribution system 107, a uniform and symmetric mold filling may be achieved during the manufacture of control piston 81.

FIG. 8 shows a top view of control piston 81 according to FIG. 7. Eccentric gate points 93, 95, which remain on molded-on component 89 after the production, are spatially separated from actuating surface 91. Due to the representation, neither gate points 93, 95 nor distribution system 107 are visible here. Accordingly, reference is made here to the description of FIGS. 6 and 7.

However, structures 83 on the inside of main body 85 having the shape of a hollow cylinder, which enhance the flow of the hydraulic medium during the operation of the control piston, are clearly recognizable in FIG. 8.

In FIG. 9, another control piston 121 is shown. Control piston 121 is manufactured from a plastic having a fiber content of 85% with the aid of injection molding. Control piston 121 has a substantially tubular main body 123 and has an axially extending molded-on component 125 on its end face 126 having an actuating surface 127. In the installed state, the end of a push rod is in contact with actuating surface 127 and axially displaces control piston 121 within the valve housing by the energization of the electromagnet.

Molded-on component 125 comprises on one of its lateral faces 129 a gate point 131 which is located outside of actuating surface 127 for the control component.

Control piston 121 is designed as a hollow cylinder which is open at the ends on both sides and which has a substantially consistent inner diameter having annular control sections 133 on its outer periphery. In the installed state, these control sections 133 cover the through openings of a valve housing and are thus used to meter the hydraulic medium. A flow-enhancing structure 135 is introduced in the form of a plurality of adjacent grooves for the hydraulic medium on the inner periphery of control piston 121.

Furthermore, similarly to the previously described figures, side 137 which is opposite molded-on component 125 is designed for the positioning of a pressure spring, via which control piston 121 may be reset against the force of the push rod.

### LIST OF REFERENCE NUMERALS

1 control valve
3 control piston
5 valve housing
7 main body
9 end face
11 molded-on component
13 actuating surface
15 lateral face
17 gate point
19 middle axis
21 ring grooves
23 through opening
25 inner chamber
27 control section
29 side
31 distribution system
33 distribution webs
35 connecting webs
37 connecting channels
39 peripheral surface
43 molded-on element
51 control piston
53 main body
55 end face
57 molded-on component
59 actuating surface
61 gate point
63 lateral face
65 middle axis
67 control section
69 side
71 distribution webs
73 connecting channels
75 peripheral surface
79 molded-on element
81 control piston
83 structure
85 main body
87 end face
89 molded-on component
91 actuating surface
93 gate point
95 gate point
97 lateral face
99 lateral face
101 middle axis
103 control sections
105 side
107 distribution system
109 distribution webs
111 connecting webs
121 control piston
123 main body
125 molded-on component
126 end face
127 actuating surface
129 lateral face
131 gate point
133 control section
135 structure
137 side

What is claimed is:

1-9. (canceled)

10. A control valve for a cam shaft adjuster comprising:
a valve housing; and
an injection-molded control piston axially displaceably mounted within the valve housing, the control piston having a substantially tubular main body, the control piston having an actuating surface for a control component on one end face, the control piston having on an end side an axially extending molded-on component including a gate point on a lateral face.

11. The control valve as recited in claim 10 wherein the gate point is located apart from the actuating surface for the control component.

12. The control valve as recited in claim 10 wherein the gate point is situated eccentrically in relation to a central axis of the control piston.

13. The control valve as recited in claim 10 wherein the molded-on component includes a distribution system having a number of distribution webs extending from the gate point to the outside.

14. The control valve as recited in claim 13 wherein the distribution system additionally includes a plurality of connecting webs via which the distribution webs are connected to the main body of the control piston.

15. The control valve as recited in claim 13 wherein the distribution system is rotationally symmetrical with respect to a central axis of the control piston.

16. The control valve as recited in claim 10 wherein the control piston is made of a plastic.

17. The control valve as recited in claim 10 wherein a material of the control piston includes mineral fibers and/or glass fibers in a range between 75 percent and 95 percent by volume.

18. The control valve as recited in claim 10 wherein the control piston is produced as a two-part piece.
